(19) United States
(12) Patent Application Publication
(10) Pub. No.: US 2010/0325824 A1
(43) Pub. Date: Dec. 30, 2010

(54) MATERIAL HANDLING

(76) Inventors: Garry Maxwell Baum, Victoria (AU); Ronald Keith O'Connor, Victoria (AU)

Correspondence Address: EDWIN D. SCHINDLER, 4 HIGH OAKS COURT, P.O. BOX 4259, HUNTINGTON, NY, 11743-0777, US

(21) Appl. No.: 12/918,941

(22) PCT Filed: Aug. 19, 2009
(86) PCT No.: PCT/AU09/01061

§ 371 Date: Aug. 23, 2010

(30) Foreign Application Priority Data
Aug. 21, 2008 (AU) 2008904291

(51) Int. Cl. E01H 1/02

(52) U.S. Cl. 15/87

(57) ABSTRACT

An apparatus for material handling that is connected to a prime mover and preferably located forward of the mover, includes a plurality of rotary brushes with each of the rotary brushes being independently suspended and having their axes substantially normal to a surface and rotating in the same direction. The rotary brushes, when moving along the surface, tend to cause any material on the surface to be moved from one brush to another brush until the material on the surface is delivered to one side of the apparatus.

### TECHNICAL AREA

This invention relates to material handling and, in particular, to material handling of loose material. It specifically relates to the handling of loose materials on soft or uneven surfaces, but is not restricted to this application. A specific application lies in the cleaning of poultry sheds, particularly sheds for chickens or turkeys.

### BACKGROUND TO THE INVENTION

It is often necessary to thoroughly clean uneven surfaces such as the dirt floors of poultry sheds.

Chickens and other poultry, which will generally herein be referred to as chickens, which are bred for the table are of a very pure strain and are susceptible to sickness and sickness in a shed can lead to the death of hundreds of thousands of chickens.

Thus, between each batch of chickens the shed must be thoroughly cleaned and sterilised. The floors of such shed may be dirt floors which are not perfectly smooth and are covered with sawdust, straw or wood-chips and, during the period of growth of the chickens, to this can be added chicken faeces, food and other impurities. These must all be removed and the area sterilised prior to a new set of chickens being brought into the shed.

This has normally necessitated a substantial amount of labour.

Often, the bulk of material is removed by being picked up by a bucket front mounted on a skid steer loader, such as a Bob-Cat (Registered Trade Mark) or a front end loader and this may be delivered externally of the shed, such as onto a truck or fed to a conveyor in the shed from whence it is delivered.

Further cleaning may be effected by a mechanical broom which may be transversely mounted on the front of a further vehicle and which delivers the material for collection.

These brooms have been mounted on a more-or-less horizontal axis, often at an angle to the direction of movement so that the material is delivered to one side. It has been found that where the floor of the shed is anything other than smooth, these tend to leave pockets of unswept material which have to be hand-cleaned later or, if sufficient pressure is placed on the brush to ensure that these portions are cleaned, this tends to both damage the remainder of the brush and also can disturb the surface of the shed. Also, previous mechanical sweepers have had a disadvantage in that there are often columns to which the side facing of the shed is connected and the previously known mechanical brooms have not been able to effectively clean up to the periphery of the columns.

### OUTLINE OF THE INVENTION

It is the object of the present invention to provide a machine for sweeping material which is suitable for use on surfaces which are uneven whereby the material is delivered to a position where it is relatively easy to handle and also which can readily sweep around obstructions on such surfaces.

The invention includes a machine for material handling being associated with or adapted for connection to a prime mover, a series of rotary brushes each independently suspended, having their axes more-or-less normal to the surface and rotating in the same direction which brushes, when moving along the surface, tend to cause any material on the surface to be moved from one brush to the other until it is delivered to one side of the machine.

It ir preferred that the machine is located ahead of the prime mover which may be a skid steer loader, such as a Bobcat

It is preferred that the brushes are in echelon and overlap each other relative to the forward movement of the machine.

It is also preferred that there are at least three and preferably four brushes.

The machine may have a frame having means for connection to a prime mover and a bar which extends at least across the width of the prime mover and at an angle to the direction of movement of the prime mover, each brush being attached to the bar on a forwardly extending mount which is pivotally connected to the bar and including means to limit the downward movement of the mount and brush relative to the bar, each brush being rotationally driven by an hydraulic motor associated with the mount.

The machine can, if required, be a hand-operated machine having driving wheels and an external handle for control of the machine by an operator or can be a self-propelled ride-on machine of the type where the driving wheels are at the front of the machine and the steering is done by a wheel or wheels at the rear of the machine.

The brushes are circular brushes and are preferably driven in the same direction but it may be preferred that some of them contra-rotate if this gives a better movement of the material.

In order that the invention may be more readily understood one specific embodiment of the machine will be described.

### DESCRIPTION OF AN EMBODIMENT OF THE INVENTION

In order that the invention will be readily described, reference will be made to the accompanying drawings, in which:

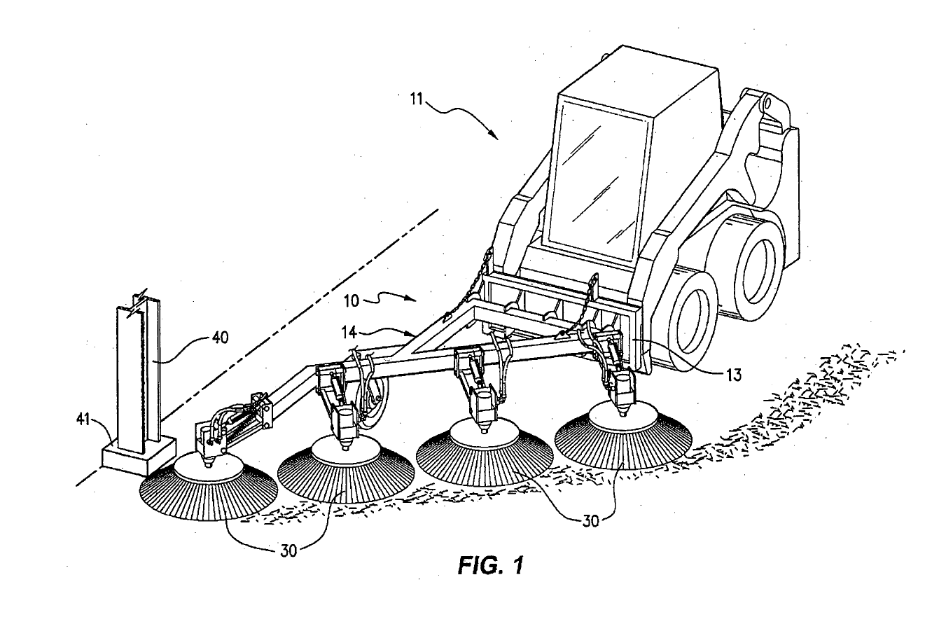

FIG. 1 is a view of the machine associated with a prime mover from the front;

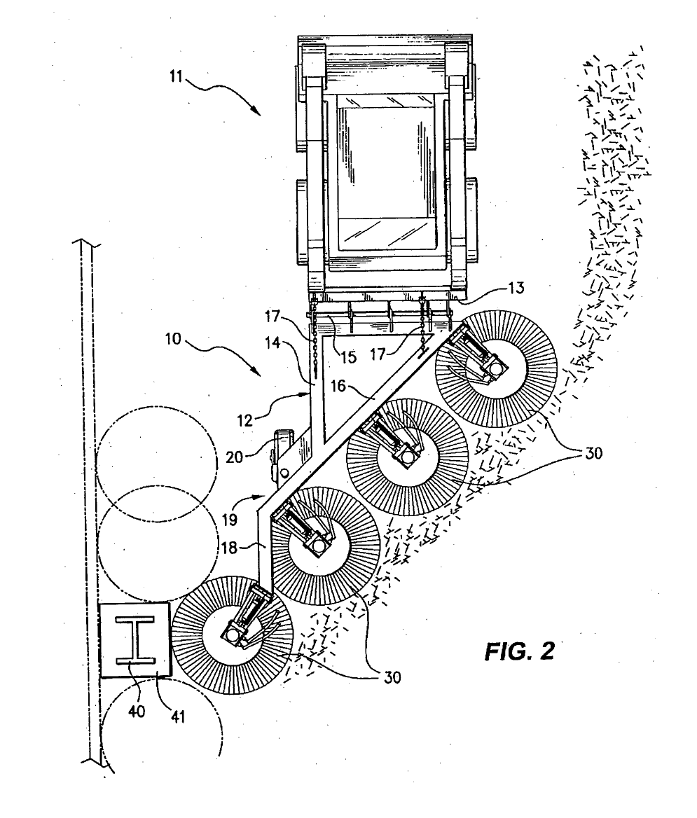

FIG. 2 is a plan view of the machine illustrated in FIG. 1;

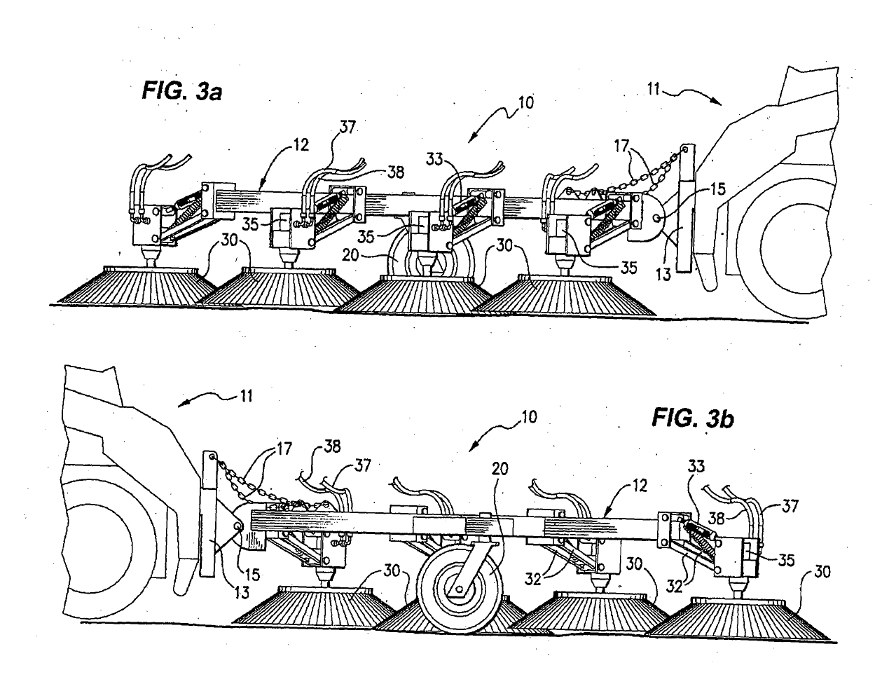

FIG. 3a is a view of the machine from one side thereof;

FIG. 3b is a view similar to that of FIG. 3a from the other side;

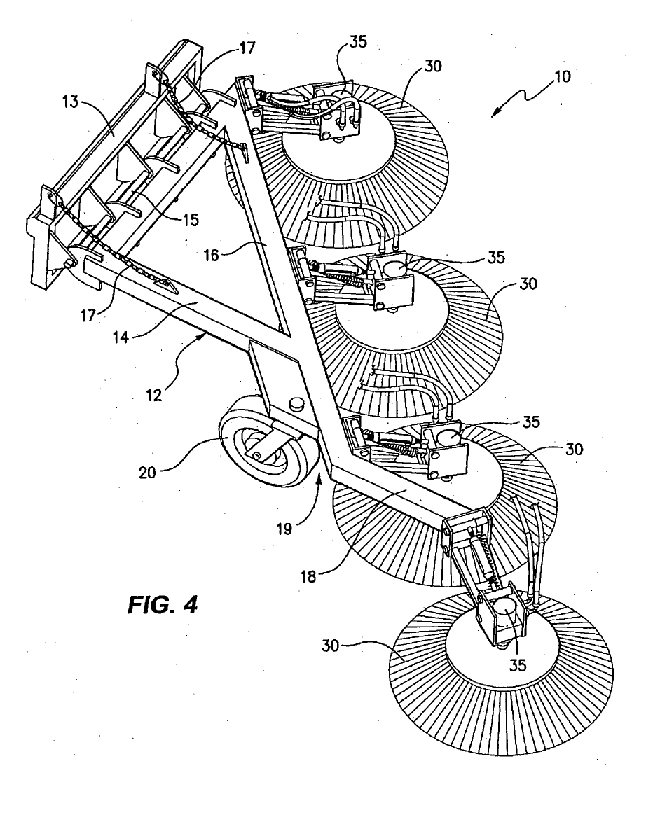

FIG. 4 is a view of the machine from above;

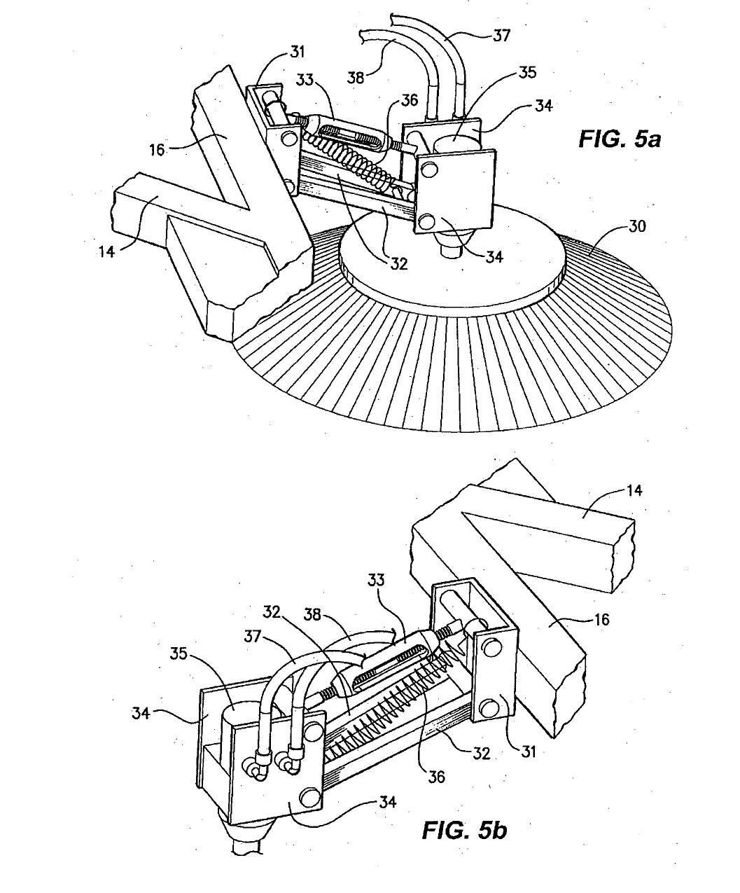

FIG. 5a is a view of one of the brushes showing its manner of connection to the frame of the machine; and

FIG. 5b shows the connection from the other side.

The machine shown in these drawings is specifically designed for use in cleaning poultry sheds and will be described as such, but it is to be understood that it can also be used for cleaning other areas.

Poultry sheds, as mentioned above often have internal columns 40 supporting the walls and roof and it is necessary to be able to, clean closely around these and often have dirt floors and the cleaning should be such as to minimise any damage to the floor. At the same time to minimise the likelihood of infection, cleaning must be very thorough.

The machine of the invention can be adapted to be connected to a prime mover or can be directly associated with a prime mover.

As illustrated, the machine 10 is shown front-mounted onto a Bobcat (Registered Trade Mark) 11 which is a well-known machine used in material handling applications and is adapted for front-mounting of equipment. It also has a hydraulic system from which pressure hydraulic fluid may be obtained and a hydraulic lift mechanism to which tools can be connected. There are other prime movers which have these features and the use of the trade mark Bobcat is for convenience.

The specific embodiment of the machine to be described is designed for the cleaning of poultry sheds and a Bobcat or similar machine can be of particular value in a case such as this where the atmosphere in poultry sheds, when the litter is being disturbed, can be undesirable, or even toxic to breathe, as a Bobcat can be provided with an air-conditioned cabin having good filtration to prevent the ingress of dust.

The machine 10 has a frame 12 which has connection means 13 which is adapted for connected to the front of the Bobcat which has a lifting arrangement to enable the vehicle to travel with the brushes removed from contact with the ground.

Forwardly directed from the connection means 13 there is the machine frame 14 to which is connected a transverse bar 16. The frame 14 may be connected to the connection means 13 by a hinge 15 which permits upward and downward movement of the frame relative to the Bobcat. As shown in FIGS. 2 and 3 there may be chains 17 which limit downward movement of the frame 14 when the device is to be transported.

The bar 16 acts as a carrier for the brushes 30 and extends at an angle to the direction of movement of the Bobcat. The bar 16 has an extension 18 to which one of the brushes is connected and to the rear 19 of this extension, there is a castering road wheel 20.

The brushes 30 are circular brushes which are conical in elevation and are provided with means whereby they can be connected to a source of driving power, in this case, as will be described, hydraulic motors 35, which directly drive the brushes.

Each of the brushes 30 are connected to the bar 16 in the same way. There is a bracket 31 having a pair of lower links 32 which are attached to plates 34 which carry the hydraulic motor 35. A single adjustable link 33, which may be in the form of a turnbuckle is also connected between the plates 31 and 34. This arrangement permits an independent up and down movement of the brush 30 relative to the bar 16 but the link 33 can adjust the position of the brush relative to the bar.

A spring 36 is also located between the plates to restrict downward movement of the brush assembly.

The oil supply to the hydraulic motors are by lines 37,38 from the hydraulic system of the Bobcat.

It will be seen from FIG. 2, that the arrangement leaves the brushes in echelon relative to the forward direction of movement of the Bobcat.

In use, the connector 13 is connected to the Bobcat and the hydraulic lines 37,38 of each of the brushes are connected to the Bobcat's hydraulic system. The frame is lowered so the ground wheel 20 comes into contact therewith and the frame is free to rotate about the hinge 15. The position of the ground wheel can be adjusted to the required rest position of the machine At this position, the brushes 30 are in contact with the ground surface and their individual positions can be set by adjustment of the turnbuckles 33.

When the hydraulic motors 35 are operated and the Bobcat is moved forwardly, material from the ground surface is picked up by the brooms and moved across and to one side where, for each of the brooms but the last, it is picked up by the adjacent broom. When it reaches the last broom it is delivered to one side thereof effectively as a windrow.

Because the brooms are floating, they will follow any irregularity of the area being cleaned's floor but at all times they tend to rest on the floor and not dig into this.

Also, as the brooms extend beyond the side of the Bobcat (FIGS. 1 & 2) the outer brooms can, for example, pass closely along a wall of the shed and remove material from thereagainst and where there is a column 40 which may be mounted on a plinth 41, can retain contact with the wall right up to the column and can then be caused to move closely around this so sweeping is effected up to and around the column.

Whilst the illustrated embodiment of machine made in accordance with the invention is shown to have four brushes, for different applications there may be more or fewer brushes than this.

It has previously been indicated herein that the assembly can be provided with an attachment means to enable ready attachment to a machine such as a Bobcat in which case it is only necessary that the attachment be made, hydraulic connections made to the hydraulic system of the Bobcat and the device is ready to operate. Alternatively, and this is more likely in the type of device that we have described in the embodiment, the device can be permanently connected to the front of a prime mover so the prime mover is basically dedicated to the device.

Also, for some applications, the device can be a rather smaller, self propelled device with which the operator either follows and controls the device or has a seat on which he/she can ride.

Further, the machine can be connected to the rear of a prime mover which has the required hydraulics such as to a three point linkage of a tractor and a connection to the tractor's hydraulic system.

These and other variations can be made in the construction of the device without departing from the spirit and scope thereof.

1-9. (canceled)

10. An apparatus for material handling for connection to a prime mover, comprising:
a plurality of rotary brushes with each rotary brush of said plurality of rotary brushes being independently suspended and having an axis that is substantially normal to a ground surface; and,
means for rotating said plurality of rotary brushes in a same direction along the ground surface, so that when moving along the ground surface, said plurality of rotary brushes tends to cause material on the ground surface to be moved from one brush to another brush of said plurality of brushes until the material is delivered to one side of said apparatus for material handling.

11. The apparatus for material handling for connection to a prime mover according to claim 10, wherein said plurality of brushes are in echelon and overlap each other relative to a forward movement of said apparatus for material handling.

12. The apparatus for material handling for connection to a prime mover according to claim 10, wherein said plurality of brushes is at least three said rotary brushes.

13. The apparatus for material handling for connection to a prime mover according to claim 12, wherein said at least three said rotary brushes is four said rotary brushes.

14. The apparatus for material handling for connection to a prime mover according to claim 10, further comprising:
a frame having means for connecting said apparatus for material handling to a prime mover;
a forwardly extending mount;
a bar extending at least across a width of the prime mover and at an angle to a direction of movement of the prime mover, each said rotary brush of said plurality of rotary brushes being attached to said bar on said forwardly extending mount that is pivotally connected to said bar; and,
means for limiting downward movement of said forwardly extending mount and each said rotary brush relative to said bar, said each rotary brush of said plurality of rotary brushes having said means for rotating said plurality of rotary brushes that comprises an hydraulic motor.

15. The apparatus for material handling for connection to a prime mover according to claim 14, wherein said frame includes at least one road wheel for supporting said frame.

16. An apparatus for material handling for connection to, and in combination with, a prime mover, comprising:
a prime mover;
means for connecting said prime mover to said apparatus for material handling;
a plurality of rotary brushes for said apparatus for material handling with each rotary brush of said plurality of rotary brushes being independently suspended and having an axis that is substantially normal to a ground surface; and,
means for rotating said plurality of rotary brushes of said apparatus for material handling in a same direction along the ground surface, so that when moving along the ground surface, said plurality of rotary brushes tends to cause material on the ground surface to be moved from one brush to another brush of said plurality of brushes until the material is delivered to one side of said apparatus for material handling.

17. The apparatus for material handling for connection to, and in combination with, a prime mover according to claim 16, wherein said apparatus for material handling is located forward of said prime mover and in a direction of movement of said prime mover.

18. The apparatus for material handling for connection to, and in combination with, a prime mover according to claim 16, wherein said plurality of brushes are in echelon and overlap each other relative to a forward movement of said apparatus for material handling.

19. The apparatus for material handling for connection to, and in combination with, a prime mover according to claim 16, wherein said plurality of brushes is at least three said rotary brushes.

20. The apparatus for material handling for connection to, and in combination with, a prime mover according to claim 19, wherein said at least three said rotary brushes is four said rotary brushes.

21. The apparatus for material handling for connection to, and in combination with, a prime mover according to claim 16, further comprising:
a frame having means for connecting said apparatus for material handling to said prime mover;
a forwardly extending mount;
a bar extending at least across a width of said prime mover and at an angle to a direction of movement of said prime mover, each said rotary brush of said plurality of rotary brushes being attached to said bar on said forwardly extending mount that is pivotally connected to said bar; and,
means for limiting downward movement of said forwardly extending mount and each said rotary brush relative to said bar, said each rotary brush of said plurality of rotary brushes having said means for rotating said plurality of rotary brushes that comprises an hydraulic motor.

22. The apparatus for material handling for connection to, and in combination with, a prime mover according to claim 21, wherein said frame includes at least one road wheel for supporting said frame.

23. An apparatus for material handling, comprising:
a prime mover;
a frame attached to a forward end of said apparatus for apparatus for material handling;
a bar in combination with said frame and extending across a width of said prime mover and at an angle thereto;
a plurality of rotary brushes with each rotary brush of said plurality of rotary brushes being independent suspended relative to said bar and each said rotary brush having an axis substantially normal to a ground surface; and,
means for rotating said plurality of rotary brushes in a same direction along the ground surface, so that when moving along the ground surface, said plurality of rotary brushes tends to cause material on the ground surface to be moved from one brush to another brush of said plurality of brushes until the material is delivered to one side of said apparatus for material handling.

24. The apparatus for material handling for connection to a prime mover according to claim 23, wherein said frame includes at least one road wheel for supporting said frame.
